(19) United States
(12) Patent Application Publication
(10) Pub. No.: US 2008/0250791 A1
(43) Pub. Date: Oct. 16, 2008

(54) Electric power station with CO2 sink and production of industrial chemicals

(76) Inventor: Howard A. Fromson, Stonington, CT (US)

Correspondence Address: ALIX YALE & RISTAS LLP, 750 MAIN STREET, SUITE 1400, HARTFORD, CT, 06103, US

(21) Appl. No.: 12/012,594

(22) Filed: Feb. 4, 2008

Related U.S. Application Data
(63) Continuation-in-part of application No. 11/786,932, filed on Apr. 13, 2007.

(51) Int. Cl. F02C 7/00

(52) U.S. Cl. 60/783

(57) ABSTRACT

A system and method for generating electricity at a desert site comprises a power plant having a combustion unit that burns aquatic bio fuel to produce electricity for distribution to a grid and an exhaust stream containing carbon dioxide. An exhaust gas distribution system connects the combustion unit with a large inland basin of salt water at the site, for growing a plant bloom in the basin. The bloom is harvested and converted into the bio fuel that is burned in the combustion unit. The basin is continually supplied by a source of salt water selected from an ocean, sea, bay, or cove. A salt extraction plant is on site for producing sea salt from water drawn from the basin, and a chemical production plant is on site for converting the extracted sea salt into at least one of sodium hydroxide and chlorine gas using some of the generated electricity.

### RELATED APPLICATION

This application is a continuation in part of U.S. application Ser. No. 11/786,932 filed Apr. 13, 2007 for “Aquatic Sink for Carbon Dioxide Emissions with Biomass Fuel Production”, the entire disclosure of which is hereby incorporated by reference.

### BACKGROUND

The present invention relates to the large scale generation of electric power from the combustion of hydrocarbons and the treatment of the associated carbon dioxide emissions.

Scientists and government policy makers are expressing growing concern about the effects on the global environment, of the continuing increase in the release of man-made waste materials into the atmosphere. One source of such concerns is the release of carbon dioxide (CO₂) as a byproduct of the combustion of hydrocarbon fuels. CO₂ is emitted in relatively low quantities by each of many individuals, such as by driving automobiles and burning fuel to heat homes. Larger emitters can be found in many industrials sites where fuels are burned to generate heat necessary for sustaining metallurgical and other chemical reactions. Emissions on a very large scale are produced by the burning of hydrocarbon fuel such as coal, oil, or natural gas in central electric generating stations, i.e., power plants.

Recent estimates of the annual production of CO₂ from the combustion of fossil fuels range as high as 1.7 billion tons. According to U.S. Pat. No. 3,999,329 the typical flu gas from a thermal power generating station utilizing coal, contains about 21% CO₂, 70% N₂, 5% water, and 2% oxygen along with significantly lower percentages of sulfur oxides and nitrous oxides.

In general, such CO₂ emissions have three natural sinks. The first is the upper levels of the atmosphere, the second is terrestrial plant life which through photosynthesis converts the CO₂ into carbohydrates, and the third is via absorption at the surface of the oceans, which converts the CO₂ into carbonic acid. Efforts at reducing CO₂ in the atmosphere have been largely focused on reducing energy demand, improving the efficiency of combustion processes, and reducing the CO₂ content of combustion exhaust before release into the atmosphere.

As discussed in U.S. Pat. No. 6,667,171 some have suggested the sequestration of CO₂ in large bodies of water, deep mines, or outdoor ponds, but have also recognized associated problems. U.S. Pat. No. 6,477,841 describes a method of converting solar energy stored via photosynthesis in macroalgae, into electrical energy.

All of these approaches are of a relatively small, incremental scale. A more fundamental approach is needed.

### SUMMARY

The present invention takes a related but broadly different approach to the overall objective of reducing the level of CO₂ in the atmosphere.

Over time, public and individual modes of transportation will rely more and more on electricity as replacing internal combustion as the source of motive power. The end user will thus generate little or no CO₂, but the central power plants that generate electricity will increase in number or capacity and continue to generate CO₂ from combustion of hydrocarbon fuels. The underlying motivation for the present invention is that if central power plants could generate and distribute electricity for use in electrically powered vehicles without adding net CO₂ to the atmosphere, the present release rate of CO₂ associated with internal combustion for transportation would be decreased dramatically.

My previously filed patent application laid the foundation for this approach. The combustion process in fossil fueled power plants can be viewed as yielding two products: the thermal energy that is the desired product for generating electricity, and waste CO₂, which can be a raw material used in a process for growing an aquatic biomass. The biomass is harvested and rendered usable as a fuel source, in a recycling system. The CO₂ emissions from a hydrocarbon combustion unit are discharged into a large body of water, which acts as a CO₂ sink. The capture of the CO₂ in the water prevents that CO₂ from entering the atmosphere. In addition, the CO₂ in the water participates in a photosynthesis process for growing a plant bloom in the water which can be harvested, and converted into a fuel for reuse in the combustion unit.

According to the present invention, this type of recycling system is provided in a more specific form, as adapted for installation in a large, relatively desolate, desert located inland but relatively close to an essentially infinite source of salt water such as an ocean or sea. A large, natural or artificial basin in the desert is continually supplied with salt water from the source. The basin can have a perimeter that extends for many miles (e.g., 10-50 miles), providing a surface area of many square miles (e.g., 15 to 150 square miles) at an average depth of many feet (e.g., 10-50 feet). Depending on the respective equipment capability, processing capacity, and consolidation efficiencies, (1) a plurality of power plants can be distributed around the shoreline, each with an associated biomass recovery and processing system, or (2) a cluster of centralized power plants receive bio fuel from a plurality of bio mass processing stations distributed around the shoreline, or (3) a cluster of bio mass processing stations produce and deliver bio fuel to a plurality of power plants distributed around the shoreline.

In a preferred implementation, a companion facility is provided for extracting salt from evaporation of the sea water from the basin, and an electrolytic processing facility is provided for producing sodium hydroxide (NaOH) and chlorine gas from the extracted salt, using electricity from the power plant.

An important aspect is that the salinity of the basin is maintained within the limits for effective growth rate of the sea plants (e.g., algae) to be used in the bio fuel production. Salinity control is provided by the independent control of the flow of salt water into the basin from the source, and the evaporation rate of the water in the basin. The most expedient control of the latter is to provide a shallow auxiliary pond adjacent the main basin, such that water from the basin having relatively high salinity is removed from the basin while source water having a relatively low salinity is supplied to the basin.

In as much as the pond water has the higher salinity, and preferably has a high surface area to volume ratio, the pond is suitable for the evaporative production of salt. The electrolytic processing facility would preferably be located adjacent to the salt extraction facility.

Another advantage of such a large scale complex is that the creation and replenishment of such a large basin can ameliorate to some extent, the expected rising levels of the oceans, especially if the complex is replicated many times,

Thus, a system and method are provided for processing CO₂ emissions, comprising a biomass combustion power plant that generates electricity and emits an exhaust stream containing CO₂ gas. A gas distribution system connects the combustion unit with a large basin of salt water, for discharging a plume of the gas into the water. The basin is continually supplied with salt water from a large salt water source such as an ocean, sea, bay or cove. A plant bloom grows in the CO₂ plume in the basin. A plant bloom harvesting system removes a portion of the bloom and accumulates a biomass outside the body of water. A biomass fuel extraction unit converts the biomass into a hydrocarbon fuel burned in the hydrocarbon combustion portion of an on-site electric power plant. Some of the thermal energy and/or electricity produced can be invested onsite to render the biomass useful as a fuel source. In the preferred embodiment, some of the electricity is also used for an electrolytic production of sodium hydroxide and chlorine from salt resulting from evaporation of water from the basin.

### BRIEF DESCRIPTION OF THE DRAWING

FIG. 1 is a schematic representation of the basic system and process underlying the present invention; and

FIG. 2 is a schematic representation of one integrated facility according to one embodiment; and

FIG. 3 is a schematic representation of a regionally integrated system according to another embodiment.

### DETAILED DESCRIPTION

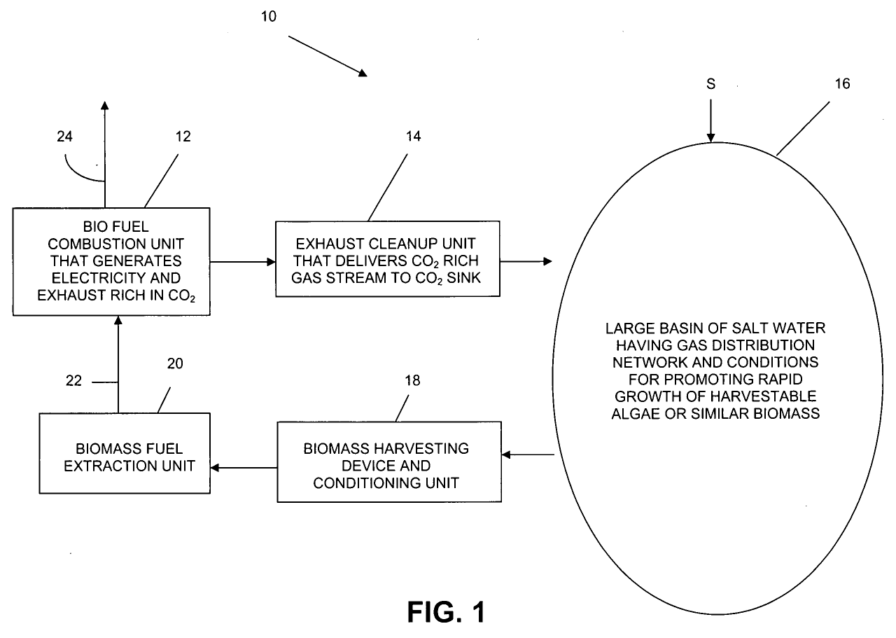

FIG. 1 shows a system 10 having a hydrocarbon combustion unit 12 that generates exhaust rich in CO₂. The combustion unit is part of a stationary central power generating station that produces electricity, having any burner type, such as fluidized bed, that can combust bio fuel derived from aquatic plants such as sea algae. Such units typically have an exhaust cleanup unit 14 for reducing the particulates, nitrate oxides (NOx) and possibly CO₂, but presently, almost all such exhaust as emitted from, e.g., a stack or chimney, contains substantial quantities of CO₂.

With the exhaust gas preferably cleaned of particulates and other potential containments, the exhaust gas is pumped or otherwise delivered to a gas distribution system that leads to a large body 16 of salt water having a distribution network and conditions for promoting rapid growth of harvestable algae or similar biomass. The body of water is preferably a large natural or artificial basin in the desert, ideally below sea level, that is continually fed salt water from an intake source S situated offshore in an ocean, sea, bay, or cove.

An aspect of the preferred embodiment is that the basin 16 is very large, for example but not limited to a perimeter that extends for many miles (e.g., 10-50 miles), providing a surface area of many square miles (e.g., 15 to 150 square miles) at an average depth of many feet (e.g., 10-50 feet). This would have a high impact on the quality of human life if located in a densely populated area, but it is contemplated that the basin and the hardware described herein would be located in hot, dry, desolate areas that are deemed wasteland. Suitable sites include the Sahara desert in Africa, and Death Valley in the U.S. The entire system 10 associated with a given basin could occupy 15 to 150 or more square miles, in a geographic region where the population density occupied by the site was (before construction) less than one person per square mile.

The body of water can be as deep as sunlight is able to penetrate, in some instances simulating a relatively calm offshore aquatic environment.

U.S. Pat. No. 5,309,672, “Submerged Platform Structure for Open Ocean Macroalgal Farm Systems”, describes an open ocean farm structure for attachment of macroalgal plants. The frame structure is made up of linear elements connected with nodes to form a three dimensional truss. The linear elements are composed of tubes containing solid rods which are screw connected to the nodes. The ends of the tubes abut the nodes so that screwing the rods into the nodes puts the tubes in compression. The truss structure thus formed is strong and flexible. Because the truss structure is made of tubes having minimal cross sectional area, the structure is relatively transparent to the forces of wave motion. The disclosure of this patent is hereby incorporated by reference, and is merely representative of the enhancements that can be provided in the body of water for promoting the rapid growth of harvestable algae.

The piping and nozzles for discharging the CO₂-laden exhaust gas in an ideal pattern and volume to produce a plume optimized for use in conjunction with, for example, the submerged platform structure described above, would be well within the ordinary skill of engineers and craftsman who design and assemble gas handling and distribution systems, and marine biologists taking into account the depth, salinity, temperature range, wave motion, and type or types of algae or similar blooming plant material to be grown. Other factors are the latitude and seasonal changes and thus variations of the intensity and penetration of sunlight as well as the prevalence of sunlight relative to cloudy or other less desirable conditions for photosynthesis process by which the plants produce carbohydrates using the sunlight and CO₂.

It should also be appreciated that, ideally, all of the CO₂ rich gas stream from the combustion unit is discharged into the body of water, which acts as a CO₂ sink, preventing the CO₂ from entering the atmosphere, and that all or most of that CO₂ in the body of water participates in the photosynthesis process, thereby preventing excess build up of CO₂ in the body of water. With a dedicated body of water associated with inland combustion units, the rate of CO₂ discharge into the body of water should more closely match the rate of utilization of CO₂ in the biomass.

The algae bloom can be harvested at 18 using known techniques. The harvesting devise will of course have an active front end which removes the algae from the bloom or from the stationary position if grown on a latticework, and a back end on land where conditioning, such as washing and/or drying and other forms of cleaning can be performed. Such drying can be implemented using some of the exhaust stream from the exhaust cleanup unit 14 or the combustion unit 12.

The conditioned biomass is transferred to the biomass fuel extraction unit 20, where the carbohydrates are converted into a usable fuel and preferably delivered back to the combustion unit via line 22. U.S. Pat. No. 4,341,038 describes a method for obtaining oil products from algae. In particular, oil products and a high nitrogen content residue are obtained by growing halophilic algae in saline solution, harvesting an algae-saltwater slurry, solvent extracting the slurry, then recovering the product and residue. According to this patent and with further reference to U.S. Pat. No. 4,115,949, such algae can be cultivated in order to obtain hydrocarbon mixtures essentially similar to fossil oil. The disclosures of these patents are hereby incorporated by reference.

The bio fuel is combusted at 12 and the resulting net electricity generated (excess over that used internally in the system 10) is delivered at 24 to a trunk line or distribution system.

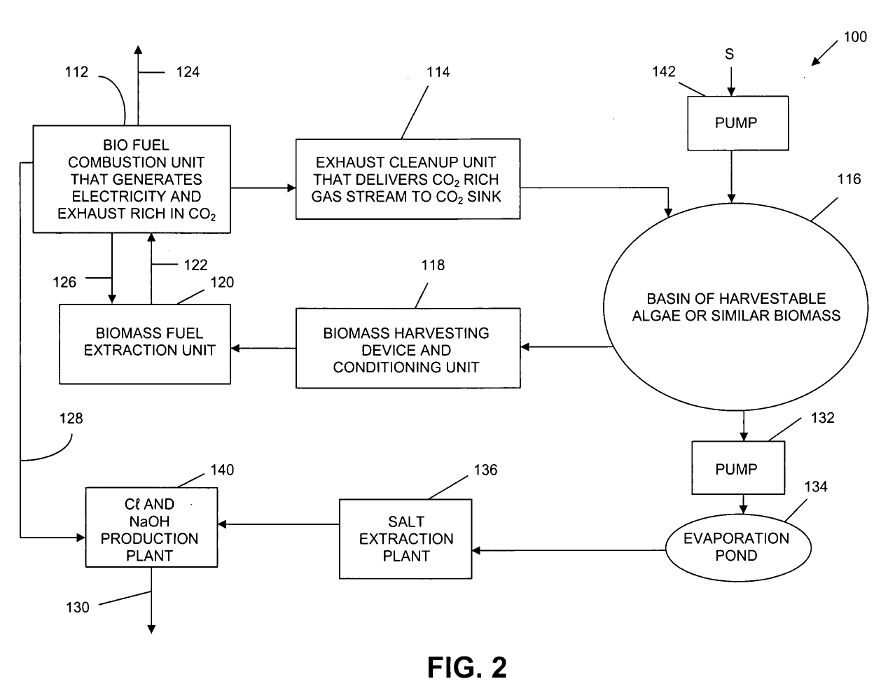

FIG. 2 shows another embodiment 100 having a companion chemical production facility. As in the system of FIG. 1, combustion power plant 112 exhausts waste gas which is cleaned at 114 and distributed in the salt water basin 116. Bio material is harvested and conditioned at 118, biomass fuel extracted at 120, and delivered as fuel via line 122 to the combustion unit at 112. The net electricity is output at 124.

FIG. 2 shows internal use of the generated electricity such as at 126 for the fuel extraction unit, and 128 for the on-site companion industrial chemical production facility shown schematically at 132, 134, 136, and 140.

As a result of evaporation, the salinity of the water in basin 116 would increase over time, to the point where it becomes commercially attractive to extract common sea salt (NaCl). However, the salinity of the water in basin 166 must not exceed the limit tolerated by the growing plant material. In a further embodiment, some of the water in basin 116, having a relatively high salinity, is pumped 132 to an auxiliary evaporation pond 134, which provides a feed supply to the salt extraction plant 136. The produced salt is delivered to a chemical production plant 140, where the resulting NaOH and chlorine gas are output at 130 as commercially salable products. These compounds are used in huge quantities for industrial processes throughout the world, and would find a ready market.

In FIGS. 1 and 2 the source S is preferably at a higher elevation than the desired water level in basin 16 or 116, so that a gravity based aqueduct system can be used for supplying sea water to the basin. Where this is not feasible, one or more supply pumps 142 are utilized. In the embodiment of FIG. 2, a workable system can be implemented without a separate evaporation pond 134, such that the salt extraction plant draws feed material directly from a specially designed shallow portion of the basin 116. However, for two reasons the system works most effectively with a pump 132 to a separate, shallow pond 134. First, the evaporative increase in salinity for a known and controllable volume of pond water can be more easily controlled. Second, the volume and salinity of the main basin 116 can be controlled by the independent control of pumps 142 and 132 as between the inlet flow rate of natural sea water and the discharge flow rate of higher salinity water from the basin into the evaporation pond 134.

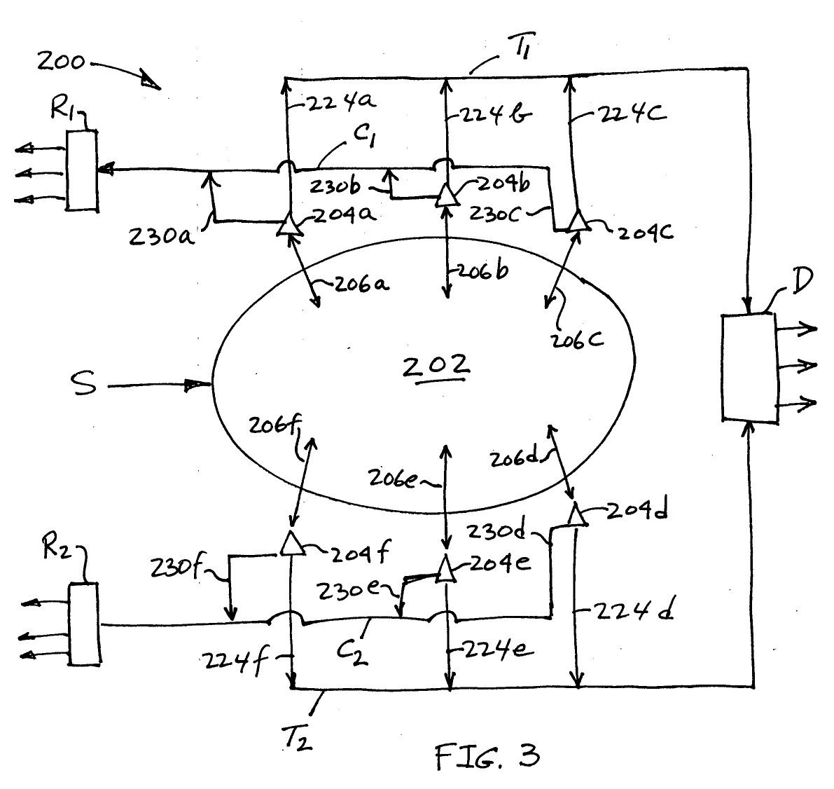

FIG. 3 is a schematic of another embodiment 200, where the full benefit of the invention can be realized in a massive complex. The basin 202 is relatively large, for example 10 miles long by 5 miles wide, situated in a desolate region of a desert. A source S of sea water feeds the basin. A plurality, such as six, integrated stations 204a, 204b, . . . 204f are located adjacent the shoreline of the basin, whereby the CO₂ exhaust is distributed into the basin and the biomass is harvested from the basin, as indicated at 206a, 206b, . . . 206f respectively. Each of the stations 204 includes the functional elements shown in FIG. 2, i.e., a combustion power plant 112 that exhausts waste gas cleaned at 114 and distributed in the basin 116 (now common basin 202), biomass harvesting and conditioning unit 118, biomass fuel extraction unit 120, and companion industrial chemical production facility 132, 134, 136, and 140.

Each of the stations 204a . . . 204f has two main outputs 224a . . . 224f and 230a . . . 230f corresponding to net electrical power and industrial chemicals as indicated at 124 and 130 in FIG. 2. Each of the electricity outputs 224 is delivered to a trunk line T1 or T2 that feeds an electrical distribution station D. This station is connected to a regional grid for distribution to, e.g., an entire country or group of countries. Each of the chemical outputs 230 can feed a collection line C1 or C2 that delivers the chemicals to one or more truck or rail depots R1, R2 for shipment to wholesale distributors. The trains can be electrified from trunk lines T1, T2, or the trucks can be fueled with diverted biofuel.

It is contemplated that the entire system or complex shown in FIG. 3 and a surrounding buffer zone of at least about 10 miles will be constructed in a geographic area having a pre-construction population density no greater than about one person per square mile. Although it is preferred that any of the embodiments of FIG. 1, 2, or 3 be located near the source of salt water, it is believed that the larger the complex the more likely it would be located quite some distance from the source of salt water, e.g., beyond 100 miles.

It should be appreciated that, given the scale of a complex as described above associated with a basin having an area of many square miles, certain terms used herein should be interpreted taking into account such scale. For example, an inland basin can be considered “near” an ocean or sea even at a distance of 100 miles. A plant located “adjacent” or “near” the shoreline could be many hundreds of yards away from the edge of the water. A given plant has many subsystems or functional units as well as other support systems associated with any industrial facility, which taken together as a “site” can sprawl over many acres. Similarly, a condition that each of a plurality of plants be “spaced along” the shoreline is consistent with a plant located many hundreds of yards away from the edge of the water, and does not require the same distance between plants, nor positional symmetry relative to the shape of the basin.

What is claimed is:

1. A system for generating electricity at a site comprising:
a power plant having a combustion unit that burns aquatic plant bio fuel to produce electricity and an exhaust stream containing carbon dioxide gas;
an exhaust gas distribution system connecting the combustion unit with a large inland body of salt water at the site, for discharging a plume of said gas into the water;
a plant bloom growing in the plume in the body of water;
a plant bloom harvesting system that removes a portion of the bloom and accumulates a biomass outside the body of water; and
a biomass fuel extraction unit that converts the biomass into a hydrocarbon fuel that is burned in the power plant.

2. The system of claim 1, wherein the gas distribution system includes means for removing contaminants other than carbon dioxide from the exhaust stream.

3. The system of claim 1, wherein the bloom harvesting system includes means for conditioning the biomass before delivery to the fuel extraction unit.

4. The system of claim 1, wherein the body of water is a basin continually supplied by a source of salt water selected from an ocean, sea, bay, or cove.

5. The system of claim 4, including
a salt extraction plant on site for producing common sea salt from water drawn from the basin; and
a chemical production plant on site for converting the extracted sea salt into at least one of sodium hydroxide and chlorine gas.

6. The system of claim 5, wherein
the chemical production is an electrolytic process; and
an electricity supply path extends from the power plant to the chemical production plant.

7. The system of claim 5, wherein
an auxiliary evaporation pond receives relatively high salinity water from the basin; and
the salt extraction plant draws said high salinity water from the evaporation pond.

8. The system of claim 4, wherein
the basin has a surface area of at least about 10 square miles; and a plurality of said power plants are spaced along the shoreline of the basin.

9. The system of claim 8, wherein
said plurality of power plants each delivers electrical power to a common distribution station connected to an electric grid.

10. The system of claim 8, wherein at least some of said plurality of power plants includes
a salt extraction plant for producing common sea salt from water drawn from the basin; and
a chemical production plant for converting the extracted sea salt into at least one of sodium hydroxide and chlorine gas; and
an electricity supply path extending from the power plant to the chemical production plant.

11. The system of claim 10, wherein
the basin is located in a desert at least 100 miles from a natural salt water source selected from an ocean, sea, bay, or cove;
an aqueduct connects the source to the basin;
an inlet controller delivers salt water from the aqueduct to the basin;
an evaporation pond is situated adjacent the basin;
a discharge controller delivers salt water from the basin to the evaporation pond; and
the salt extraction plant produces salt from the evaporation pond.

12. The system of claim 1, wherein
the body of water is a desert basin continually supplied by a source of salt water selected from an ocean, sea, bay, or cove;
a salt extraction plant is on site for producing common sea salt from water drawn from the basin; and
a chemical production plant is on site for converting the extracted sea salt into at least one of sodium hydroxide and chlorine gas.

13. The system of claim 12, wherein
an auxiliary evaporation pond receives relatively high salinity water from the basin; and
the salt extraction plant draws said high salinity water from the evaporation pond.

14. The system of claim 13, including
means for controlling a flow rate of salt water from the source into the basin; and
means for controlling an outflow of salt water from the basin to the auxiliary pond.

15. A method of generating electricity at an inland site comprising:
operating at least one power plant having a combustion unit that burns aquatic plant bio fuel to produce electricity and an exhaust stream containing carbon dioxide gas;
connecting the combustion unit with a large inland body of salt water at the site, for discharging a plume of said gas into the water;
growing a biomass in the plume in the body of water;
harvesting a portion of the bloom and accumulating a biomass outside the body of water;
converting the biomass into a hydrocarbon fuel that is burned in the power plant;
continually supplying the body of water from a source of salt water selected from an ocean, sea, bay, or cove;
evaporatively extracting common sea salt from water from the body of water; and
delivering some of the produced electricity offsite.

16. The method of claim 15, including
constructing a basin having an area of at least about 15 square miles and a depth of at least about 10 feet in a desert where the population density is less than about one person per square mile;
constructing a plurality of said power plants spaced apart along the shore of said basin;
each power plant discharging said gas into said basin and burning bio fuel obtained from biomass grown in said basin.

17. The method of claim 15, including
delivering some water from the basin body of water to an auxiliary pond;
evaporatively extracting common sea salt from said pond; and
reducing the salinity of the water in the body of water by controlling the rate of inflow from the source to the body of water and the rate of outflow from the body of water to the pond.

18. The system of claim 1, including means for controlling the salinity of said body of water.

19. The system of claim 18, wherein said means for controlling salinity includes an auxiliary pond that draws off relatively high salinity water from the body of water.

20. The system of claim 19, wherein said means for controlling salinity includes
means for controlling a flow rate of salt water from the source into the body of water; and
means for controlling an outflow rate of salt water from the body of water to the auxiliary pond.
